(19) United States
(12) Patent Application Publication
(10) Pub. No.: US 2019/0187020 A1
(43) Pub. Date: Jun. 20, 2019

(54) EVENT DRIVEN GAS SENSING AND SOURCE ATTRIBUTION

(71) Applicant: International Business Machines Corporation, Armonk, NY (US)

(72) Inventors: William Green, Irvington, NY (US); Levente Klein, Tuckahoe, NY (US); Yves C. Martin, Ossining, NY (US); Ramachandran Muralidhar, Mahopac, NY (US); Michael Alan Schappert, Wappingers Falls, NY (US); Theodore van Kessel, Millbrook, NY (US)

(21) Appl. No.: 15/843,249

(22) Filed: Dec. 15, 2017

(51) Int. Cl. G01M 3/16; H04Q 9/02; G08B 21/12

(52) U.S. Cl. CPC G01M 3/16; H04W 4/005; G08B 21/12; H04Q 9/02

(57) ABSTRACT

Techniques for facilitating event driven gas sensing and source attribution are provided. In one example, a computer-implemented method comprises generating, by a device operatively coupled to a processor, a gas sensor signal indicative of sensing a gas based on the sensing the gas by one or more sensors. Additionally, the computer-implemented method can comprise converting, by the device, the gas sensor signal from an analog signal to a digital signal to identify one or more peak events based on the digital signal being determined to have satisfied a condition.

### STATEMENT REGARDING FEDERALLY SPONSORED RESEARCH OR DEVELOPMENT

This invention was made with Government support under Contract No.: DE-AR0000540 awarded by the Advanced Research Development Agency. The Government has certain rights to this invention.

### BACKGROUND

The subject disclosure relates to sensor networks, and more specifically, to event driven gas sensing and source attribution.

### SUMMARY

The following presents a summary to provide a basic understanding of one or more embodiments of the disclosure. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products that facilitate domain and client-specific application program interface recommendations are described.

According to an embodiment, a system can comprise a memory that stores computer executable components, and a processor that executes the computer executable components stored in the memory. The computer executable components of the system can comprise a sensor component that generates a gas sensor signal based on sensing a gas by one or more sensors of the sensor component. Additionally, the computer executable components of the system can comprise a signal processor component that converts the gas sensor signal from an analog signal to a digital signal to identify one or more peak events based on the digital signal being determined to have satisfied a condition.

According to another embodiment, a computer program product that facilitates gas sensing can comprise a computer readable storage medium having program instructions embodied therewith. The program instructions can be executable by a processor and the processor can generate a gas sensor signal indicative of sensing a gas based on the sensing the gas by one or more sensors of a sensor component. The program instructions can also be executable to convert, by the processor, the gas sensor signal from an analog signal to a digital signal to identify one or more peak events based on the digital signal being determined to have satisfied a condition.

According to yet another embodiment, a computer-implemented method is provided. The computer-implemented method can comprise generating, by a device operatively coupled to a processor, a gas sensor signal indicative of sensing a gas based on the sensing the gas by one or more sensors. The computer-implemented method can also comprise, converting, by the device, the gas sensor signal from an analog signal to a digital signal to identify one or more peak events based on the digital signal being determined to have satisfied a condition.

In some embodiments, one or more of the above elements described in connection with the systems, computer-implemented methods and/or computer program programs can be embodied in different forms such as a computer-implemented method, a computer program product, or a system.

### DESCRIPTION OF THE DRAWINGS

FIG. 1 illustrates a block diagram of an example, non-limiting sensor component that facilitates gas sensing in accordance with one or more embodiments described herein.

FIG. 2 illustrates a block diagram of an example, non-limiting sensor component that facilitates gas sensing in accordance with one or more embodiments described herein.

FIG. 3 illustrates a block diagram of an example, non-limiting sensor component that facilitates gas sensing in accordance with one or more embodiments described herein.

FIG. 4 illustrates an example, block diagram of an example, non-limiting system that facilitates gas sensing in accordance with one or more embodiments described herein.

FIG. 5 illustrates an example, non-limiting peak detection circuit that facilitates gas sensing in accordance with one or more embodiments described herein.

FIG. 6 illustrates an example, non-limiting remote gas sensor system that facilitates gas sensing in accordance with one or more embodiments described herein.

FIG. 7 illustrates an example, non-limiting graph of raw sensor data and peak sensor filtered data in accordance with one or more embodiments described herein.

FIG. 8 illustrates an example, non-limiting gas path approximation based on gas sensor data in accordance with one or more embodiments described herein.

FIG. 9 illustrates a flow diagram of an example, non-limiting computer-implemented method that facilitates gas sensing in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Fugitive gas sensing in the present context refers to sensing gas (e.g., methane, sulfur dioxide, etc.) concentrations in a moving air environment with the objective of sensing its presence, location, and/or magnitude. It should be noted that the processes and systems described within this disclosure can apply to determining a point of leakage for gas and/or particulates in the close proximity of a source where the typical plume model is not well developed. Developing networks of remote sensors (e.g., gas sensors, wind sensors, optical sensors, etc.) can be used to detect and facilitate the mitigation of gas leaks. For example, a plurality of sensors can be distributed proximate to areas where leaks are likely to occur. The sensors can include, but are not limited to, gas sensors, anemometers, etc. Wind currents can move the gas from the leak point around the proximity in a meandering plume. From time-to-time the plume motion can intersect with a sensor. Thus, the plume can be detected as a gas peak event at the sensor. By analyzing these peak events over time, and in the context of wind data, it is possible to estimate the magnitude and location of the leak.

To accomplish this, it is important the sensing can be performed at low cost, low power, and in large numbers to allow identification and localization of one or more leaks in remote locations over extended time periods. Consequently, most of the data exchange can be performed wirelessly, given that the sensor network can be operated in remote geographical locations.

Additionally, low power interface-to-microcontroller type computers can be utilized with the system to reduce data rates and power needed to support remote fugitive gas leak detection and isolation. Utilizing a peak detection circuit and threshold detection logic, it is possible to detect events associated with an analog sensor signal and then convert an analog signal into a digital signal. Furthermore the signal can be compressed using well established techniques like: Discrete Cosine Transform (DCT) or Walsh-Hadamard Transform (WHT) and Discrete Wavelet Transform (DWT).

In an additional embodiment, a sensor array comprising at least one gas sensor can be arranged in proximity to a potential leak source. A gas sensor system comprising the gas sensor can be operationally connected to one or more signal processing devices, wherein the one or more signal processing devices can be local or remote to the gas sensor. The gas sensor can also communicate with the signal processing devices via a wireless network.

The sensor array can further comprise global positioning system (GPS) capabilities and utilize a neural network to compute the probability of a leak in proximity to the sensor array. The peak data can be recorded and stored locally via a gateway device and/or server device and transmitted to a remote gateway device. In another embodiment, the remote gateway device can be used to process peak data from the gas sensor to estimate the presence, location, and magnitude of the gas leak.

One or more embodiments described herein can facilitate event driven gas sensing and source attribution. Additionally, one or more embodiments described herein include systems, computer-implemented methods, apparatus, and computer program products that facilitate event driven gas sensing and source attribution.

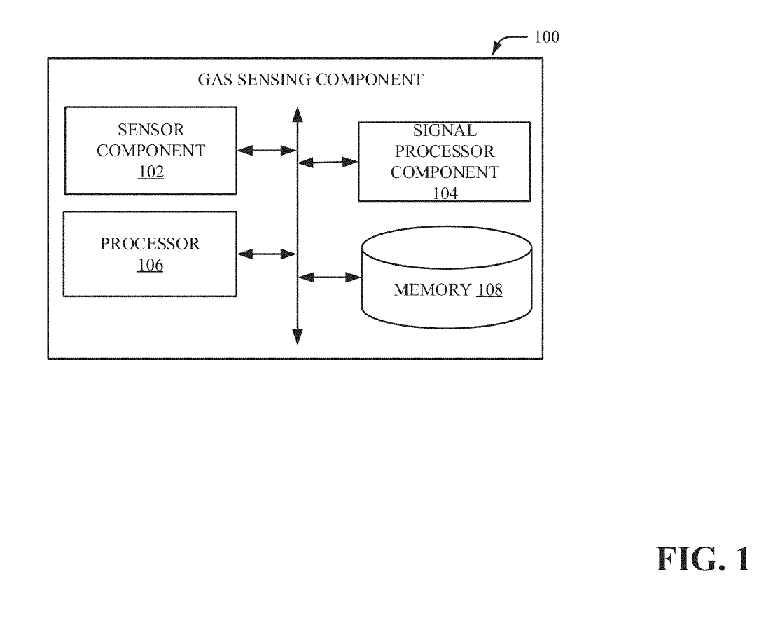

FIG. 1 illustrates a block diagram of an example, non-limiting sensor component that facilitates gas sensing in accordance with one or more embodiments described herein.

As depicted in FIG. 1, the gas sensing component 100 can comprise several subcomponents (e.g., a sensor component 102, a signal processor component 104, etc.), a processor 106 and a memory 108, which can be electrically and/or communicatively coupled to one another in various embodiments. It should also be noted that, in some embodiments, the subcomponents (e.g., the sensor component 102, the signal processor component 104, etc.) can be external to the gas sensing component 100.

Aspects of the processor 106 can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described by the gas sensing component 100. In an aspect, the gas sensing component 100 can also include memory 108 that stores computer executable components and instructions.

In one embodiment, the gas sensing component 100 can detect peak events via the sensor component 102 and the signal processor component 104. The sensor component 102 can include, but is not limited to: battery sensors, global positioning system sensors, time sensors, a data repository, a communication system, etc. The sensor component can be configured to detect a specific gas and its concentration in real-time and communicate data associated with the gas to a computer. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology.

It should be understood that the computer can be local to or geographically remote to the sensor component 102 and/or the gas sensing component 100. The computer can be operable to communicate with any wireless devices or entities operatively disposed in wireless communication, (e.g., a sensor, scanner, portable data assistant, communications satellite, any piece of equipment or location associated with a wirelessly detectable tag, and/or a telephone). This includes at least Wi-Fi and Bluetooth™ wireless technologies. Thus, the communication can be a defined structure as with a conventional network or simply an ad hoc communication between at least two devices.

A peak event can be detected based on a sensing rule. A sensor signal S(t) can be generated based on gas data received by the sensor component 102. For instance, when the sensor signal S(t) exceeds a first threshold value t1 and the sensor signal is less than a previously stored peak value P(S(t)) by an amount that exceeds a second threshold value t2 (not shown in FIG. 1), the sensing rule can be held as true. Thus, if the sensor component 102 has sensed an indication of methane, then the sensor signal generated from the sensor component 102 can be used as a variable in the aforementioned sensing rule. Consequently, for signals that conform to the aforementioned rule, peak events can be generated as a function of time. Thus, for a given amount of time, a count value and/or an interval value can be transmitted from the sensor component 102 to the computer. It should also be noted that the threshold value can be a defined threshold value.

Prior to the transmission, the signal processor component 104 can digitize the sensor signal for use in transmitting the sensor data. However, it should be noted that peak detection can be performed in a digital domain or an analog domain. For example, in a case where the signal is digitized (e.g., at 100 hertz (Hz)) via the signal processor component 104, only a few bytes of data associated with the peak detection may need to be transmitted per minute instead of transmitting kilobytes of data per minute. In a typical system, the computer, transmitter, and receiver can utilize a substantial amount of power. However, utilizing low power analog and digital elements, the signal can be monitored and counted without operating the transmitter for extended periods of time (e.g., seconds, minutes, etc.). In essence, sensor data is only transmitted when one or more peaks occur. The sensor data can comprise: a peak time, a peak amplitude, a full width of a peak, a half maximum of a peak, a baseline value, etc. Alternatively, the count can also be transmitted at short wake up intervals in 2 to 4 byte packets as opposed to the typical 2 kilobytes of data to be transmitted per second at continuous operation of the computer.

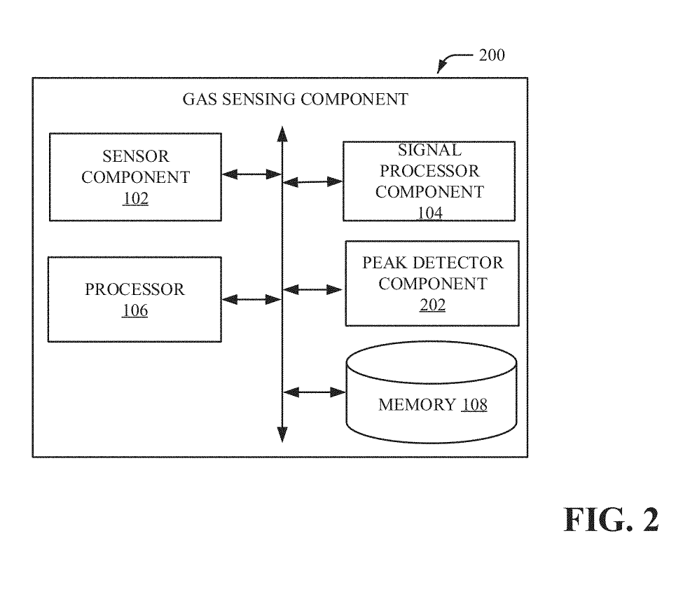

FIG. 2 illustrates a block diagram of an example, non-limiting sensor component that facilitates gas sensing in accordance with one or more embodiments described herein. Repetitive description of like elements employed in other embodiments described herein is omitted for sake of brevity.

The gas sensing component 200 can also comprise a peak detector component 202. The peak detector component can be operable to detect a peak of a sensed gas. For example, the peak detector component 202 can process the sensor data, received from the sensor component 102, by stripping the baseline data from the sensor data. The baseline data is data associated with the sensors while they are not at a peak sensing state. Consequently, the remaining sensor data can comprise the peak data. The remaining sensor data can be utilized by the peak detector component 202 to identify the peaks associated with a detected gas.

The peak detector component 202 can also leverage other sensor data to identify the gas or a location associated with the gas. For example, based on previously curated data obtained by the gas sensing component 200, the system can infer that a specific peak time and/or peak amplitude is associated with a specific gas type and/or leakage location of the specific gas type. For instance, sensors sensing a gas with a higher magnitude can be inferred to be closest to the gas leak than sensors that sense that same gas at a lower magnitude.

In another embodiment, the peak detector component 202 can digitize the peak event prior to being reset, and the peak event value can be used as an index in a histogram array where the count value data versus peak value data are accumulated. Consequently, the data can be shifted and binned in a low-dimensional array for more efficient transmission where the size of the transmission can be proportional to the dimension of the array.

In another example, a process for penalizing a sensor while preferring another sensor, based on accuracy in determining the gas type and location, can be facilitated with an example automatic classifier system and process. An example classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that can be automatically performed (e.g., identifying a location of a gas leak). For example, a specific sensor can be identified as being more relevant than others when determining a gas leak associated with a specific location. Consequently, sensor data from that specific sensor can be weighted more heavily by a neural network in relation to determining the gas and the location of the gas leak.

A support vector machine (SVM) is an example of a classifier that can be employed. The SVM can operate by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, fuzzy logic models, and probabilistic classification models providing different patterns of independence can be employed. Classification as used herein also may be inclusive of statistical regression that is utilized to develop models of priority.

The disclosed aspects herein can employ classifiers that are explicitly trained (e.g., via generic training data) as well as implicitly trained (e.g., via observing gas sensing and leakage locations as it relates to the triggering events). For example, SVMs can be configured via a learning or training phase within a classifier constructor and feature selection module. Thus, the classifier(s) can be used to automatically learn and perform a number of functions, including but not limited to predicting a gas leak, calculating a probability of the predicted gas leak, updating a graphical user interface with predicted gas leak data, and so forth. The criteria can include, but is not limited to, defined values, contribution attenuation tables or other parameters, preferences and/or policies, and so on.

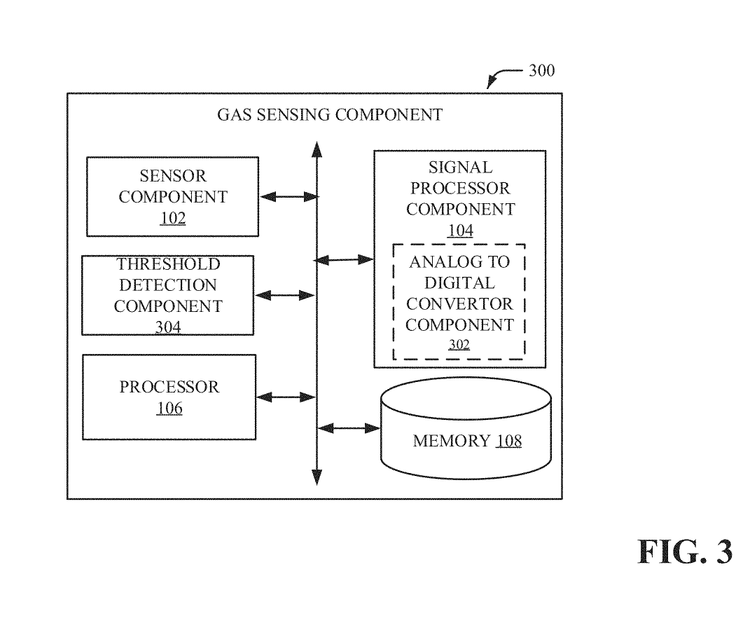

FIG. 3 illustrates a block diagram of an example, non-limiting sensor component that facilitates gas sensing in accordance with one or more embodiments described herein. Repetitive description of like elements employed in other embodiments described herein is omitted for sake of brevity.

In another embodiment, the gas sensing component 300 can comprise a threshold detection component 304 and the signal processor component 104 can further comprise an analog to digital converter component 302, which can be electrically and/or communicatively coupled to one another in various embodiments. The threshold detection component 304 can be operative to receive threshold data and apply the threshold data to the gas data. Peaks can generally be determined based on an increased level of gas data. Therefore, rules can be applied by the threshold detection component 304 to determine when and where a peak event exists. For example, the threshold detection component 304 can receive rules from the computer and/or it can generate rules based on the classifier methodology discussed above with regards to FIG. 2. A rule might state that any amplitude of a gas associated with sensor data under a certain threshold value should be treated as baseline sensor data. However, any amplitude data over the threshold value or within a defined range above the threshold value, shall be treated as a peak event.

It should also be noted that although magnitude sensor data may indicate a peak event for one gas, that does not necessarily indicate a peak event for the same magnitude sensor data for another gas. Thus defined threshold parameters can be different for different gasses based on their potency, deadliness, or some other factor. For example, a peak event for carbon monoxide can be substantially easier to trigger (e.g., lower threshold value) than a peak event for oxygen.

As mentioned above, the signal processor component 104 can also comprise an analog to digital converter component 302.

The analog to digital converter component 302 can convert the analog signal from the sensors into a digital signal. The analog to digital converter component 302 can also comprise an isolated an electronic device that converts an input analog voltage or current to a digital number representing the magnitude of the voltage or current. Thus, the digital output can be a binary number that is proportional to the input from the gas sensors. The signal can be digitized and further processed to perform a peak extraction operation with time constant limitations, thereby producing a digital record of a peak event comprising the time of occurrence, peak magnitude, and peak width. This binary number can then be sent to the computer over the wireless network via one of the protocols described above.

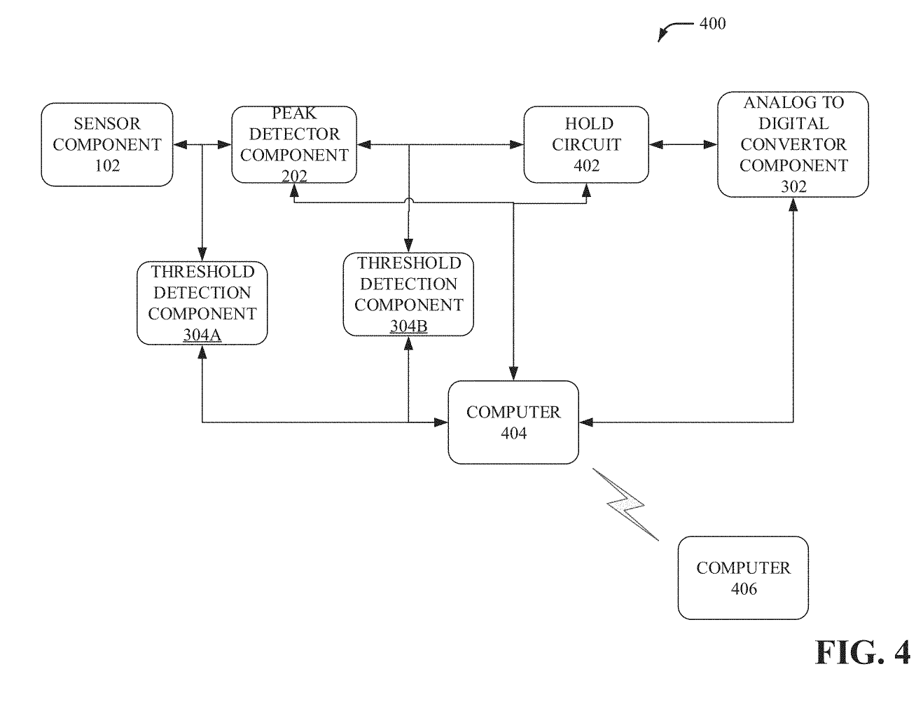

FIG. 4 illustrates an example, block diagram of an example, non-limiting system that facilitates gas sensing in accordance with one or more embodiments described herein. Repetitive description of like elements employed in other embodiments described herein is omitted for sake of brevity.

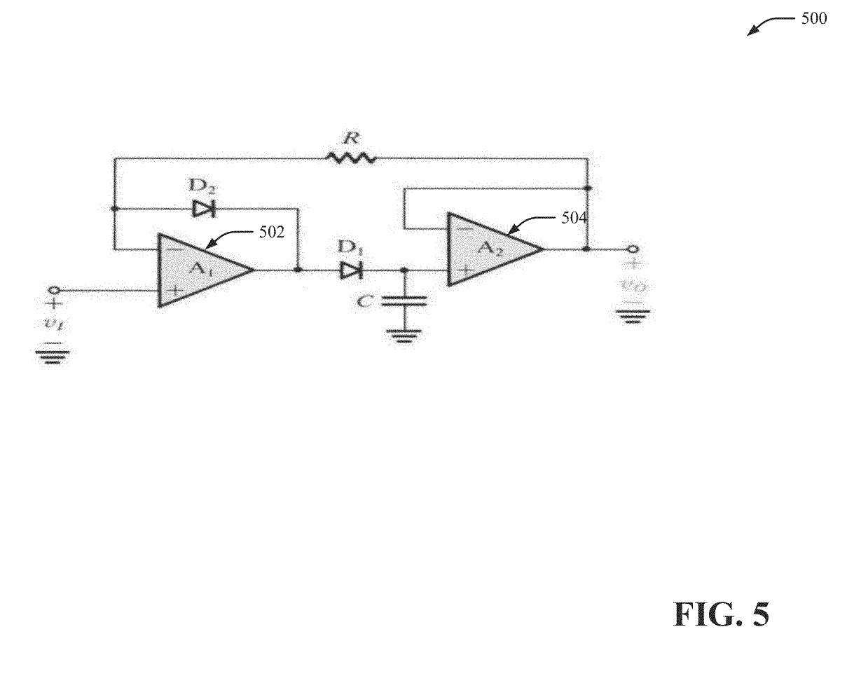

FIG. 4 depicts an analog peak detection system 400 utilizing a simple peak detection circuit with analog threshold sensing and a hold circuit 402 to provide peak timing and information to a computerized analog to digital conversion system. In this embodiment, the sensor component 102 can be an analog sensor component that can generate an analog signal that is processed through a peak detector component 202 and a threshold detection component 304A. The peak detector component 202 can store the highest signal value since the last reset it received in a capacitor (as depicted in FIG. 5). When a gas signal that exceeds a threshold value is received, the peak detector component 202 is reset and the signal is observed until it falls below a second threshold sensed at the threshold detection component 304A relative to the peak detector component 202 output. Consequently, the hold circuit 402 is triggered and the value of the peak magnitude is converted by the analog to digital converter component 302. The analog signal is received by the hold circuit 402, and it keeps that value constant until the analog to digital circuit samples and records the signal when the voltage value is released. A computer 404 can then be used to reset the peak detector component 202, the hold circuit 402, and the analog to digital converter component 302. Data from the computer 404, can then be wirelessly communicated to another computer 406.

An analog peak detection system 400 of this type is easily constructed with low power electronic components. Additionally, the operations associated with the analog peak detection system 400 can also be performed wherein the computer continuously converts the gas sensor signal from analog to digital and the peaks are identified by processing the digital information. Although this method uses additional power, the volume of data to be analyzed is reduced, and the number of events per sensor is not typically more than a few per minute. Reduced data volume is reflected in a lower power requirement from the wireless radio to transmit the data.

Accordingly, there is a good tradeoff between processing the data (peak detect) and transmission radio operation to achieve an overall low power operation setpoint.

In another embodiment, the analog peak detection system 400 can be implemented by having a local data acquisition system comprising the sensor component 102, power, the hold circuit 402, and the analog to digital converter component 302 attached to a computer with communication capabilities. In this embodiment, the algorithm described above is carried out digitally. The gas sensor signal output is converted using the analog to digital converter component 302 to convert a series of measurements at appropriate time intervals (e.g., 0.01 seconds). Thus, a sequence analyzed by the computer can be used to identify the gas peak width, magnitude, and time of occurrence using the algorithm described above or similar method.

FIG. 5 illustrates an example, non-limiting peak detection circuit that facilitates that facilitates gas sensing in accordance with one or more embodiments described herein. Repetitive description of like elements employed in other embodiments described herein is omitted for sake of brevity. The circuit depicted in FIG. 5 comprises two operational amplifiers 502, 504 that ties the output signal from the second operational amplifier 502 as an input of the first operational amplifier 504 as feedback to identify the maximum value of the signal in the circuit.

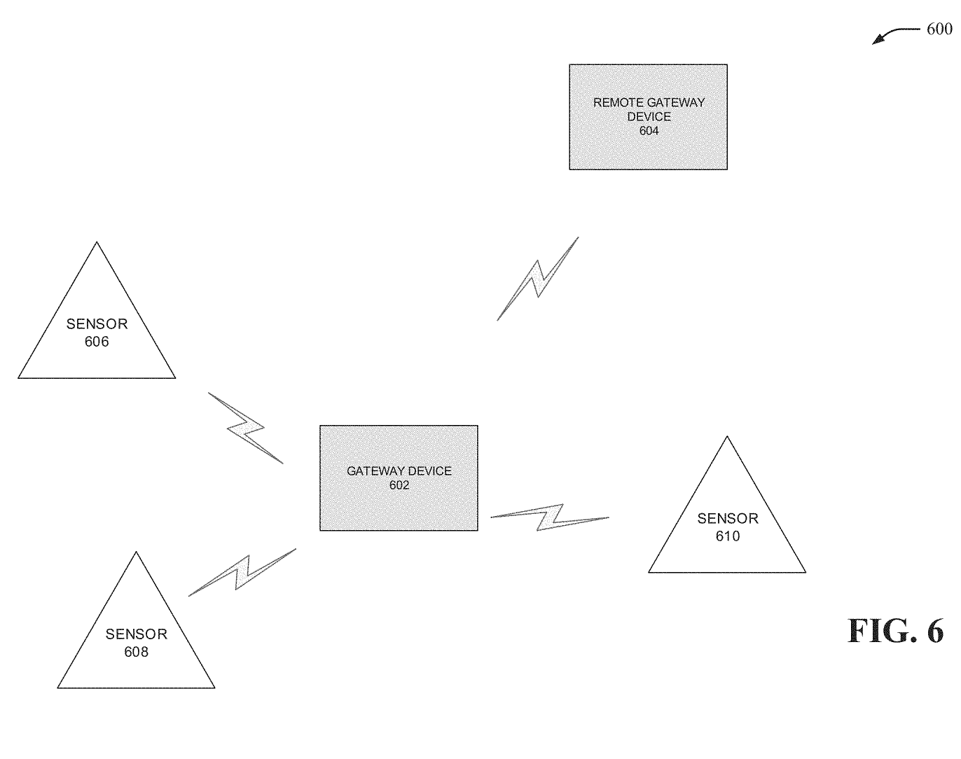

FIG. 6 illustrates an example, non-limiting remote gas sensor system that facilitates gas sensing in accordance with one or more embodiments described herein. Repetitive description of like elements employed in other embodiments described herein is omitted for sake of brevity.

It should be understood that despite the depicted sensors and gateways, any number of sensors and gateways can be used to form the peak detection system 600 and that FIG. 6 shall not be limiting. It should be noted that the gateway device 602 can comprise the gas sensing components 100, 200, 300. In another embodiment, one or more sensors can be operationally coupled to a server device a gateway device 602, and/or a remote gateway device 604 of the peak detection system 600 similar to the one previously described. The one or more sensors 606, 608, 610 of the peak detection system 600 can communicate with the gateway device 602. Additionally, the one or more sensors 606, 608, 610 can communicate wirelessly with each other, and the gateway device 602 can receive and interpret the data from the one or more sensors 606, 608, 610. For example, a gas plume may take a route from the sensor 606 to the sensor 610 without triggering the sensor 608. This data can be sent to the gateway device 602, which can determine that the gas leak is from a western location and the wind has carried it to a more easterly location. Additionally, it would be expected that the concentration of the gas plume is higher at the sensor 606 because the concentration will have dissipated by the time the gas plume has reached the sensor 610, thus indicating that the gas leak is closer to the sensor 606.

One or more of the sensors 606, 608, 610 can also be a wind sensor operable to estimate the presence, location, and/or magnitude of a gas leak in proximity to the sensor array. For instance, now referring to the aforementioned example, the sensor 610 can be a wind sensor, which can indicate that the wind is blowing in a western to eastern direction based on the gas plum concentration being higher near the sensor 606. This data can also be relayed to a remote gateway device 604 (or alternatively to a cloud based server) at a different location than the gateway device 602 for further aggregation.

When the sensors 606, 608, 610 are local to the gateway device 602, a short range wireless transmission can be utilized to preserve power. The communication between the sensors 606, 608, 610 and the gateway device 602 can be accomplished using a mesh radio (e.g., LoRa™, DigiMesh™, etc.), a wired connection, a low power Bluetooth, WiFi or other communication protocols. Once that data has been received by the gateway device 602, the data can be processed to determine event factors (e.g., distance, direction, magnitude, source, etc.). The communication between the gateway device 602 and the remote gateway device 604 can also be accomplished using mesh radio, wired connection, low power Bluetooth, WiFi, cellular (3G or 4G), or other communication protocols typically utilized for long distance communication. Furthermore, the processed data can be made available via a graphical user interface (GUI) and displayed on a map or a display screen. The map can comprise the location of the peaks, the estimated source of the leak, the predicted type of gas, etc.

In another embodiment the peak information collected by the peak detection system 600 can be analyzed to locate the source of one or more gas leaks. For example, a distributed array of sensors 606, 608, 610 (e.g., gas sensors) can be used in conjunction with wind direction and speed sensors to estimate the location of a gas leak in proximity to the sensor array. It should be noted that the sensors 606, 608, 610 can also comprise the wind and/or speed sensors. Because leaks do not just appear in free space, to estimate the gas leak location, it can be assumed that the gas leaks emit from a surface. Thus, a peak event at a sensor 606, 608, 610 can be assumed to be the result of a leak at a surface point that took an approximately direct path to get from the leak point to the sensor detection point. The wind conditions can also facilitate a gas peak and indicate the most likely direction that the plume took to get from the leak surface point to the sensor 606, 608, 610. Since the peak can be defined as a gas concentration above a defined threshold, the peak events can be a function of that threshold value.

Consequently, to estimate the most likely location of the leak, peaks observed at the sensor 606, 608, 610 can be associated with wind data at the time of the peak to estimate the likely direction the plume took to arrive at the sensor 606, 608, 610. Additionally, intersection points can be generated for peak plume directions versus relative to other peak plume directions, thus creating a point cloud that corresponds to a likely source location. The sensor signals can be backpropagated based on the wind direction to determine intersection points. For example, synchronous wind direction can be used to facilitate the backpropagation. The wind direction can be observed prior to a peak occurring, for an averaged time prior to the peak occurring, and/or during a specific time interval. The intersection points can then be used to determine a probable location of the gas leak. The peaks can be expanded to a size that reflects the variability of the wind at the time each contributing peak occurred. Therefore, point cloud information can be recorded spatially in a two-dimensional or three-dimensional array or accumulator. It should also be noted that the sensors 606, 608, 610 can also be used to determine a plume intersection associated with multiple gasses being sensed, which can stem from multiple gas leaks. In other scenarios, the same gas can be sensed by multiple sensors, however the peak detection system 600 can determine that there are multiple leaks of the same gas from different locations. In this scenario, the centroid estimation function (as discussed below) can be used to more accurately identify the location of multiple leaks simultaneously.

The peak detector component 202 can leverage the centroid estimation function to identify the gas or a location associated with the gas.

The centroid or geometric center of a plane figure is the arithmetic mean (e.g., average) position of all the points in the shape for any object in n-dimensional space. Therefore, the centroid is the mean position of all the points in all of the coordinate directions associated with the gases. Because gases and gas leaks can plume in the x, y, and/or z coordinate, centroid estimation can be used to estimate the location of the gas leak based on the sensors 606, 608, 610 sensing the gas. For example, based on the path of a gas in accordance with a direction of wind, the peak detection system 600 can determine an average location for the gas, which can be an indicator of the gas leak location. Alternatively, the peak detection system 600 can determine multiple gas leaks by sensing multiple gases. In this scenario, the sensors 606, 608, 610 can determine each gas leak based on the gas sensed and/or the peak detection system 600 can determine where the highest concentration of gas is based on where multiple plums are cross-located.

Based on previously curated data obtained by the gas sensing component 200, the peak detection system 600 can infer that a specific peak time and/or peak amplitude is associated with a specific gas type and/or leakage location of the specific gas type. For instance, sensors sensing a gas with a higher magnitude can be inferred to be closest to the gas leak than sensors that sense that same gas at a lower magnitude. Additionally, associating a time that a specific gas peaks can be an indicator that the gas leak is at a specific location if there is data to support that the gas can only emanate at a specific location during a specific timeframe. Additionally centroid estimation can be used to confirm the location and/or used to train the peak detection system 600 as a part of the training phase mentioned in regards to the neural network above. The sensor data can also be analyzed utilizing a cluster analysis and spatial filtering to further improve the estimate.

Cluster analysis or clustering can group a set of objects in such a way that objects in the same group (e.g., the cluster) are more similar, in some sense or another, to each other than to those objects in other clusters. The clusters can then be used for exploratory data mining, statistical data analysis, machine learning as noted above, pattern recognition, image analysis, information retrieval, data compression, and/or computer graphics. For example, when the sensors 606, 606, 610 sense multiple gases, the sensor data can be clustered based on the type of gas and the predicted location. The gas clusters can then be displayed on a graphical user interface to illustrate the gas type, the leak location, and the concentration of the gas.

Clusters can include groups with small distances among the cluster members, dense areas of the data space, intervals or particular statistical distributions. Clustering can therefore be formulated as a multi-objective optimization technique. For example, the appropriate clustering algorithm and parameter settings can comprise values such as the distance of plumes and gas particulates, a defined threshold, and/or a predicted number of expected clusters.

In another embodiment, the sensors 606, 608, 610 can also comprise an infrared (IR) sensor used to detect gas particulates. IR sensors can comprise active and passive systems. For example, active IR imaging sensors can scan a laser across a field of view to detect backscattered light at an absorption line wavelength for a specific target gas. Alternatively, passive IR imaging sensors can measure spectral changes at each pixel in an image and look for specific spectral signatures that indicate the presence of target gases. The types of compounds that can be imaged are the same as those that can be detected with infrared point detectors, however, the images further assist in the identification of the location of the gas leak.

Additionally, a spatial filter can be used to alter the structure of a beam of light or other electromagnetic radiation, associated with the IR sensor. Spatial filtering can normalize the output of the IR sensors to provide more refined data points associated with the gas concentration by removing aberrations in the beam due to imperfect, dirty, or damaged optics, due to variations in the IR sensor gain medium itself. Filtering can ensure that desirable data points associated with the gas source pass through the filter, while the undesirable features are blocked. Therefore, the spatial filter can be applied to the sensor data to clean up the output of erroneous data points and further refine the data.

The sensor array can further comprise GPS capabilities and utilize a neural network to compute the probability of a leak in proximity to the sensor array. The peak data can be recorded and stored locally (e.g., via the gateway device 602) and transmitted to a remote gateway device (604). In another embodiment, the remote gateway device 604 can be used to process peak data from the gas sensors to estimate the presence, location, and magnitude of the gas leak.

The peak detection system 600 can be employed to use hardware and/or software to solve problems that are highly technical in nature (e.g., gas sensing, cluster analysis, spatial filtering, gas concentrations, gas leakage location, etc.), that are not abstract and that cannot be performed as a set of mental acts by a human due to the processing capabilities needed to facilitate gas sensing, for example. Further, some of the processes performed may be performed by a specialized computer for carrying out defined tasks related to memory operations. For example, a specialized computer can be employed to carry out tasks related to analog to digital conversion or the like.

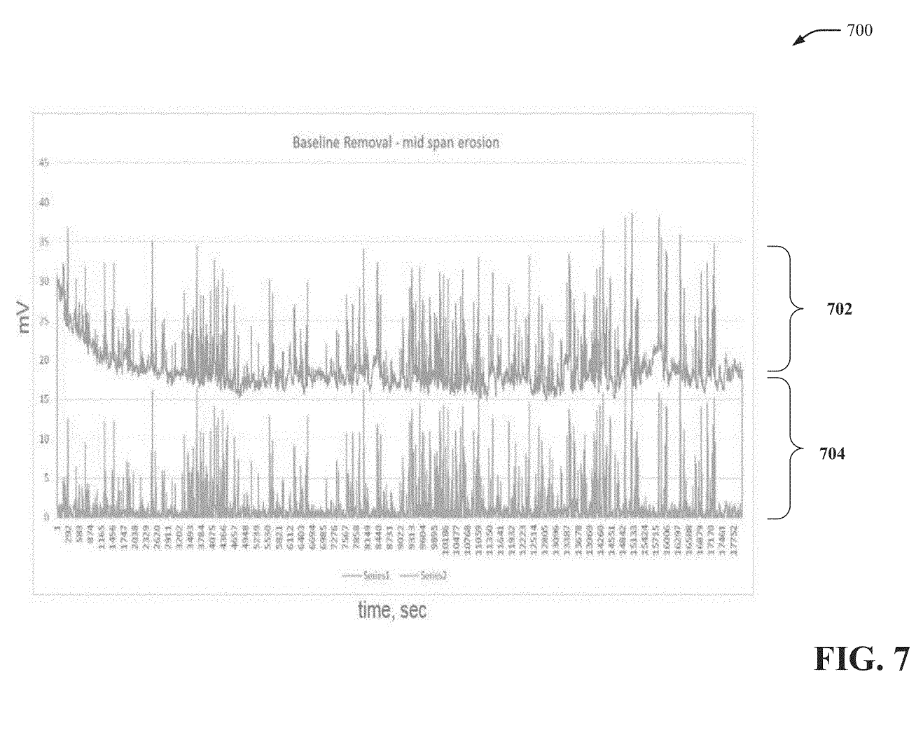

FIG. 7 illustrates an example, non-limiting graph of raw sensor data and peak sensor filtered data in accordance with one or more embodiments described herein. Repetitive description of like elements employed in other embodiments described herein is omitted for sake of brevity.

As mentioned previously, the peak detector component 202 can process the sensor data, received from the sensor component 102, by stripping the baseline data from the sensor data. The baseline data is data associated with the sensors while they are not at a peak sensing state. The baseline data is depicted by the top graph 702 of FIG. 7. Consequently, the remaining sensor data can comprise the peak sensor data as depicted by the bottom graph 704 of FIG. 7. The remaining sensor data can be utilized by the peak detector component 202 to identify the peaks associated with a detected gas.

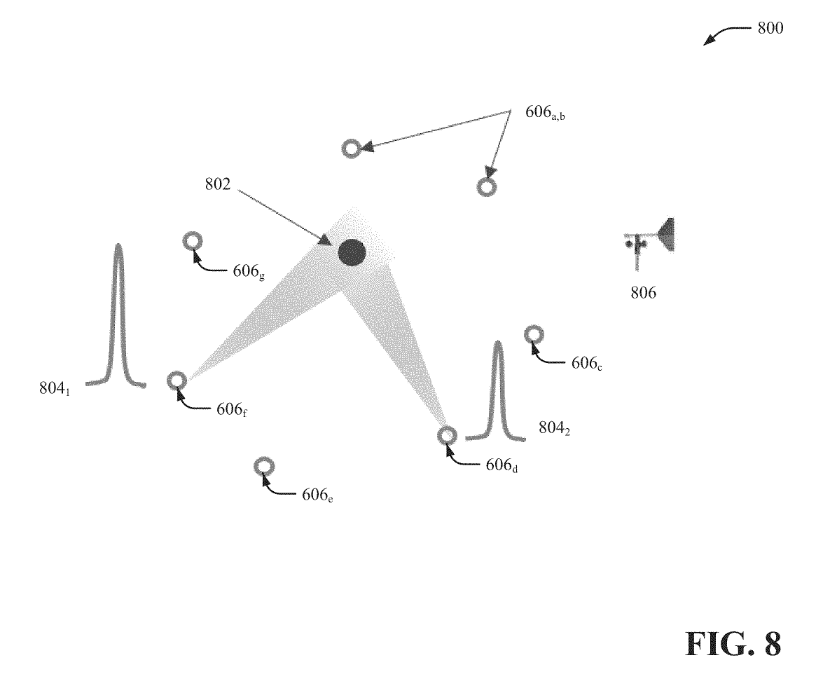

FIG. 8 illustrates an example, non-limiting gas path approximation based on gas sensor data in accordance with one or more embodiments described herein. Repetitive description of like elements employed in other embodiments described herein is omitted for sake of brevity.

FIG. 8 depicts a peak detection system 800 comprising multiple gas sensors 606ₐ, 606_{b}, 606ₑ, 606_{d}, 606ₑ, 606_{f}, 606_{g}, a wind sensor 806, and peak events 804₁, 804₂. Data from the gas sensors 606ₐ, 606_{b}, 606ₑ, 606_{d}, 606ₑ, 606_{f}, 606_{g} can be filtered to isolate peak activity from basic variations. For example, FIG. 8 depicts peak events 804₁, 804₂ being experienced by the gas sensors 606_{d}, 606_{f}, respectively. Thus, the gas levels have indicated that a threshold value has been met and/or surpassed. The peak data is considered along with the wind data at the time of the peak events 804₁, 804₂ to estimate the most likely direction the plume came from. Consequently, an intersection 802 (e.g., point where gas plumes overlap) of the plums sensed by the gas sensors 606_{d}, 606_{f}, can be determined by the gateway device 602.

The intersection 802 and wind data generated by the wind sensor 806 can provide an indication as to the location of the gas leak. It should also be noted that the peak events 804₁, 804₂ experienced by the gas sensors 606_{d}, 606_{f} can occur at different times. Because the gas plums can indicate the direction in which the gas came from, locations associated with the leaks can be zoned (e.g., labeled) by the gateway device 602. Thus, the peak detection system 800 can leverage the location data for future use. There may be situations where one or more gas leaks may be present and the system can identify one or more locations where a leak may originate.

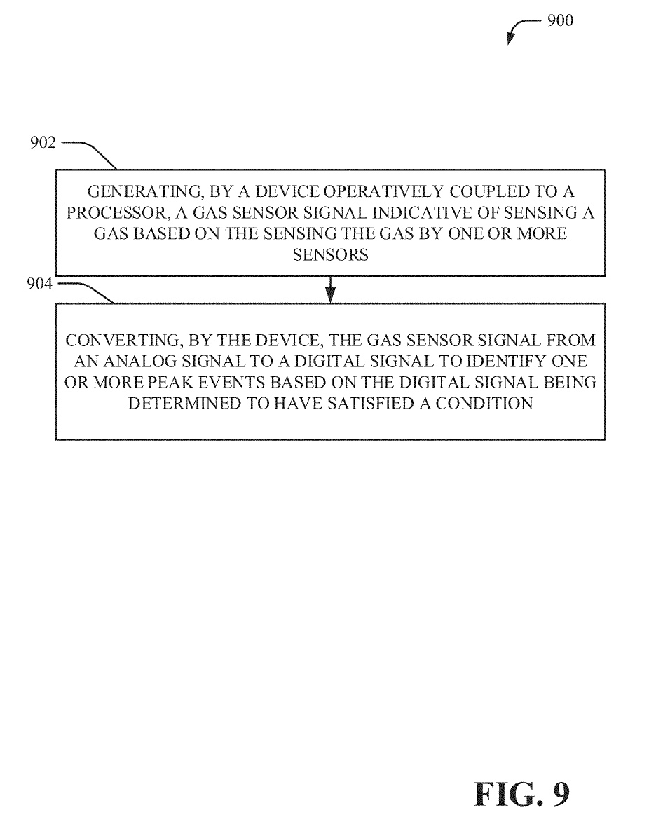

FIG. 9 illustrates a flow diagram of an example, non-limiting computer-implemented method that facilitates gas sensing in accordance with one or more embodiments described herein. Repetitive description of like elements employed in other embodiments described herein is omitted for sake of brevity.

At element 902, the computer-implemented method 900 can comprise generating (e.g., via the sensor component 102), by a device operatively coupled to a processor, a gas sensor signal indicative of sensing a gas based on the sensing the gas by one or more sensors. For example, multiple gas and wind sensors (e.g., via the sensor component) can be used to determine a location associated with one or more gas leaks. Additionally, the computer-implemented method 900 can comprise converting (e.g., via the analog to digital converter component 302), by the device, the gas sensor signal from an analog signal to a digital signal to identify one or more peak events based on the digital signal being determined to have satisfied a condition at element 904. Data from the multiple gas and wind sensors (e.g., the sensor component) can be processed by the signal processor component 104, wherein analog data from then the multiple gas and wind sensors (e.g., the sensor component) can be converted to digital data (e.g., via the analog to digital converter component 302). The converted digital data can then be sent to a network device (e.g., the gateway device 602) over a wireless network.

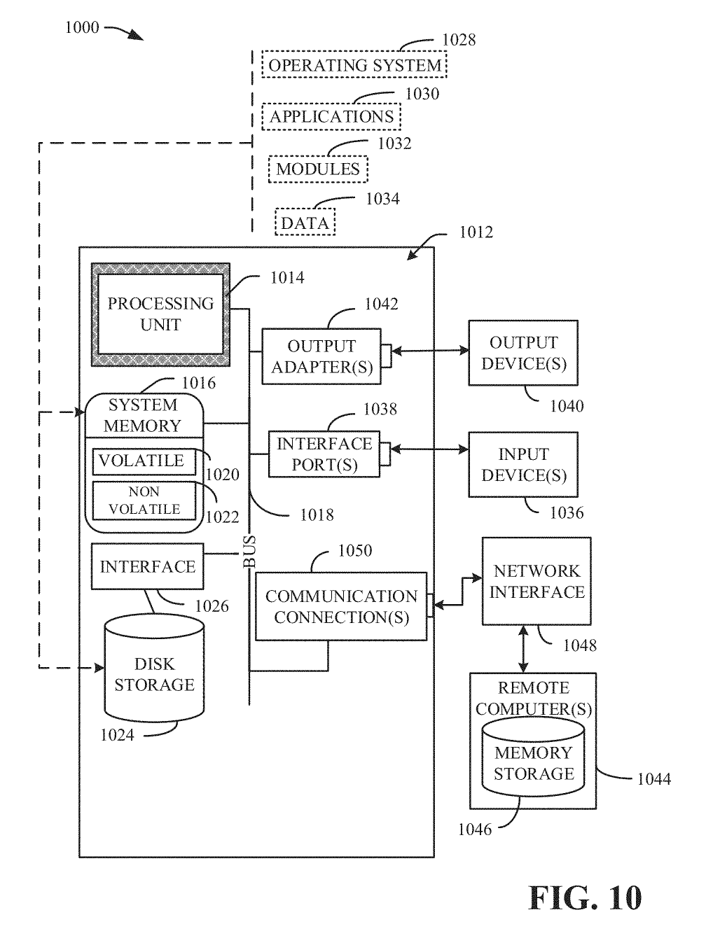

In order to provide a context for the various aspects of the disclosed subject matter, FIG. 10 as well as the following discussion is intended to provide a general description of a suitable environment in which the various aspects of the disclosed subject matter can be implemented. FIG. 10 illustrates a block diagram of an example, non-limiting operating environment in which one or more embodiments described herein can be facilitated. With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1020 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 1024, acts to control and allocate resources of the computer 1012.

System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
a sensor component that:
generates a gas sensor signal based on sensing a gas by one or more sensors; and
a signal processor component that:
converts the gas sensor signal from an analog signal to a digital signal to identify one or more peak events based on the digital signal being determined to have satisfied a condition.

2. The system of claim 1, wherein the computer executable components further comprise:
a peak detector component that analyzes a gas plume to determine a maximum value of the digital signal based upon the digital signal exceeding a threshold value, wherein the gas plume is associated with at least one of the one or more peak events.

3. The system of claim 1, wherein the condition is associated with a concentration value representative of a concentration of the gas being determined to have exceeded a defined threshold value.

4. The system of claim 2, wherein the peak detector component detects the one or more peak events as a function of time, and wherein the peak detector component receives the digital signal from the sensor component via a wireless radio communication.

5. The system of claim 2, wherein the peak detector component identifies the maximum value and a peak width of the gas plume to determine a time associated with the leak of the gas.

6. The system of claim 2, wherein the peak detector component compares a concentration value representative of a concentration of the gas of the one or more peak events to a defined threshold value.

7. The system of claim 6, wherein the system further comprises a gas sensing component that resets the peak detector component based on an indication that the concentration value has been determined to have exceeded the defined threshold value.

8. A computer program product that facilitates gas sensing, the computer program product comprising a computer readable storage medium having program instructions embodied therewith, the program instructions executable by a processor to cause the processor to:
generate a gas sensor signal based on sensing gas by one or more sensors of a sensor component; and
convert the gas sensor signal from an analog signal to a digital signal to identify one or more peak events based on the digital signal being determined to have satisfied a condition.

9. The computer program product of claim 8, wherein the program instructions are further executable by the processor to cause the processor to:
analyze a signal associated with a wind sensor to record a direction of wind and a speed associated with the wind.

10. The computer program product of claim 9, wherein the condition is associated with a concentration value representative of a concentration of the gas being determined to have exceeded a defined threshold value.

11. The computer program product of claim 9, wherein a peak detector component detects the one or more peak events as a function of time, the direction of the wind, and the speed associated with the wind.

12. The computer program product of claim 9, wherein a peak detector component identifies a peak width of a gas plume to determine a time associated with the leak of the gas.

13. The computer program product of claim 9, wherein the program instructions are further executable by the processor to cause the processor to:
utilize a peak value associated with the one or more peak events and the direction of the wind within a time interval to back propagate the signal based on the direction, wherein the time interval occurs prior to the one or more peak events being determined to have occurred;
cluster the signal to determine one or more locations associated with a highest point density; and
associate the highest point density with a location representative of a leak source.

14. The computer program product of claim 13, wherein the program instructions are further executable by the processor to cause the processor to:
reset a peak detector component based on an indication that the concentration value has been determined to have exceeded the defined threshold value.

15. A computer-implemented method, comprising:
generating, by a device operatively coupled to a processor, a gas sensor signal indicative of sensing a gas based on the sensing the gas by one or more sensors; and
converting, by the device, the gas sensor signal from an analog signal to a digital signal to identify one or more peak events based on the digital signal being determined to have satisfied a condition.

16. The computer-implemented method of claim 15, further comprising:
analyzing, by the device, a peak associated with the one or more sensors based on a direction of a wind;
generating, by the device, one or more backpropagated path intersection points to create one or more intersection point density clusters for indicating the one or more gas leaks; and
updating, by the device, an intersection point density cloud to identify one or more leak locations associated with the one or more gas leaks.

17. The computer-implemented method of claim 15, wherein the condition is associated with a concentration value representative of a concentration of the gas being determined to have exceeded a defined threshold value, and wherein the concentration value is utilized to identify a location of a leak.

18. The computer-implemented method of claim 16, further comprising:
detecting, by the device, the one or more peak events as a function of time.

19. The computer-implemented method of claim 16, further comprising:
identifying, by the device, a width of a gas plume to determine a time associated with the leak of the gas.

20. The computer-implemented method of claim 16, further comprising:
comparing, by the device, a concentration value representative of a concentration of the gas of the one or more peak events to a defined threshold value.
